(19) United States
(12) Patent Application Publication
(10) Pub. No.: US 2017/0198833 A1
(43) Pub. Date: Jul. 13, 2017

(54) MICRO CHECK VALVE APPARATUS

(71) Applicant: Panasonic Intellectual Property Management Co., Ltd., Osaka (JP)

(72) Inventors: MAKI HIRAOKA, Nara (JP); MITSUOKI HISHIDA, Osaka (JP); AKIHISA YAMADA, Osaka (JP); TOSINORI YAMANAKA, Osaka (JP); TOSHINOBU MATSUNO, Kyoto (JP)

(21) Appl. No.: 15/472,404

(22) Filed: Mar. 29, 2017

Related U.S. Application Data
(63) Continuation of application No. PCT/JP2016/004010, filed on Sep. 2, 2016.

(30) Foreign Application Priority Data
Sep. 14, 2015 (JP) 2015-180254
Jul. 26, 2016 (JP) 2016-146505

(51) Int. Cl. F16K 99/00; B01L 3/00

(52) U.S. Cl. CPC F16K 99/0057; B01L 3/502738; F16K 99/0023; F16K 2099/0084; B01L 2400/0616

(57) ABSTRACT

A micro check valve apparatus connected to a microchannel device includes: a substrate; a chamber that is positioned inside the substrate and has an upper surface having a projection, and a tapered part positioned at a lower part of the chamber; a micro discharging channel connected to a side surface of the chamber; a micro introducing channel connected to the tapered part of the chamber; and a spherical valve positioned on the tapered part.

### BACKGROUND

1. Technical Field

The present disclosure relates to a micro check valve apparatus that is connected to a microchannel device.

2. Description of the Related Art

There exists a microchannel device called a μ-TAS (Micro-total-analysis-system), which handles a minute amount, e.g., about several microliters, of a solution containing a specimen or a chemical solution, and automatically carries out an accurate liquid feeding operation for analysis.

A card-like chip (having a thickness of several millimeters, a longitudinal width of several centimeters, and a lateral width of several centimeters) included in the microchannel device includes a network of microchannels each having a width of 0.1 mm and a depth of 0.1 mm. In the card-like chip, a small amount of liquid sample is caused to flow through the microchannels, thereby subjected to an analysis process.

The amount of liquid required for the analysis is of the order of about 10 μL. Chemical processes including mixing of a biological sample and a chemical solution, extraction of the target, and detecting a molecular marker, and an analysis such as medical diagnosis are carried out with the liquid just inside the chip of the microchannel device. Since all the analysis operations of the liquid are completed within the chip, the chip is disposable. Accordingly, with the reduced risk of contamination due to leakage of any biological substance, the microchannel device is convenient to use as a simple diagnosis apparatus.

The microchannel device for automatically carrying out an accurate liquid feeding operation in a minute amount is connected, as one of important components, to a micro check valve.

NPL 1 discloses a check valve which includes a spherical element on a tapered part. Further, NPL 2 discloses various micro check valves. However, in each of NPL 1 and NPL 2, the operational flow velocity is of the order of mL/min and backflow occurs in an amount of the order of mL. Accordingly, they are not applicable to a μ-TAS chip.

### CITATION LIST

### Patent Literature

PTL 1: U.S. Pat. No. 4,911,616

### Non-Patent Literature

NPL 1: Christophe Yamahata, Frederic Lacharme, Yves Burri, Martin A. M. Gijs “A ball valve micropump in glass fabricated by powder blasting”, Sensors and Actuators B, Volume 110, published, Feb. 11, 2005 (P1-P7)
NPL 2: Kwang W Oh, Chong H Ahn “A review of microvalves”, JOURNAL OF MICROMECHANICS AND MICROENGINEERING, Volume 16, INSTITUTE OF PHYSICS PUBLISHING, Mar. 24, 2006 (P13-P39)

### SUMMARY

One non-limiting and exemplary embodiment provides, in a micro check valve apparatus which operates by a floating valve element closing a channel, a micro check valve apparatus with a reduced backflow amount and reduced variations in operation among chips.

In one general aspect, the techniques disclosed here feature a micro check valve apparatus that is connected to a microchannel device, the micro check valve apparatus including:

a substrate;

a chamber that is positioned inside the substrate and has an upper surface having a projection, and a tapered part positioned at a lower part of the chamber;

a micro discharging channel connected to a side surface of the chamber;

a micro introducing channel connected to a bottom of the tapered part of the chamber via an opening; and

a spherical valve that is capable of opening and closing the opening of the micro introducing channel by shifting upward and downward in the chamber to be spaced apart from and brought into contact with the tapered part.

The micro check valve apparatus according to the one aspect of the present disclosure provides a micro check valve apparatus with a reduced backflow amount and reduced variations in operation among chips, by virtue of the upper surface having the projection increasing the flow that pushes the spherical valve upon occurrence of backflow when the spherical valve is closing.

### BRIEF DESCRIPTION OF THE DRAWINGS

FIG. 1A is a bottom view of a first substrate of a micro check valve apparatus according to a first exemplary embodiment;

FIG. 1B is a vertical cross-sectional view of the micro check valve apparatus according to the first exemplary embodiment;

FIG. 1C is a top view of a second substrate of the micro check valve apparatus according to the first exemplary embodiment;

FIG. 2A is a bottom view of a first substrate of a micro check valve apparatus according to a reference example;

FIG. 2B is a vertical cross-sectional view of the micro check valve apparatus according to the reference example;

FIG. 2C is a top view of a second substrate of the micro check valve apparatus according to the reference example;

FIG. 3A is a vertical cross-sectional explanatory diagram showing an operation of the micro check valve apparatus of the present exemplary embodiment;

FIG. 3B is a vertical cross-sectional explanatory diagram showing an operation of the micro check valve apparatus according to the present exemplary embodiment;

FIG. 3C is a vertical cross-sectional explanatory diagram showing an operation of the micro check valve apparatus according to the present exemplary embodiment;

FIG. 3D is a vertical cross-sectional explanatory diagram showing an operation of the micro check valve apparatus according to the present exemplary embodiment;

FIG. 4A is a bottom view of the first substrate of the micro check valve apparatus according to the first exemplary embodiment;

FIG. 4B is a vertical cross-sectional view of the micro check valve apparatus according to the first exemplary embodiment;

FIG. 4C is a top view of the second substrate of the micro check valve apparatus according to the first exemplary embodiment;

FIG. 5 is a diagram showing a measurement system;

FIG. 6A is a top view of a measurement chamber;

FIG. 6B is a top view of the measurement chamber;

FIG. 6C is a cross-sectional view of the measurement chamber;

FIG. 6D is a cross-sectional view of the measurement chamber;

FIG. 7A is a photograph of a pump formed in a chip taken from its lower surface side;

FIG. 7B is a photograph of the pump formed in the chip taken from its lower surface side;

FIG. 8 is a graph of an experimental result of an example; and

FIG. 9 is a graph of factor and effect of the experimental result of parameter design.

### DETAILED DESCRIPTION

### First Exemplary Embodiment

In the following, a description will be given of an exemplary embodiment with reference to the drawings.

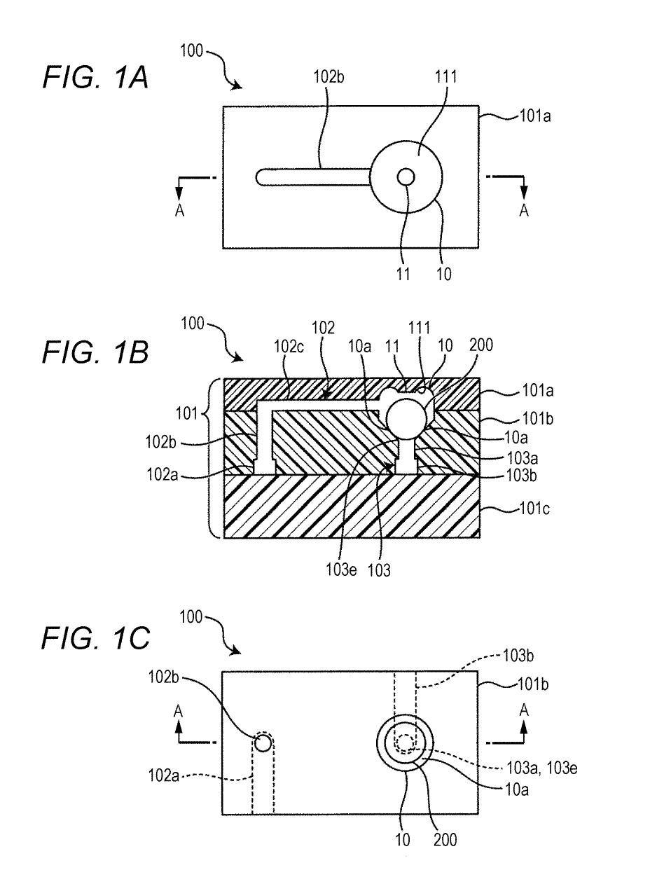

FIGS. 1A to 10 show micro check valve apparatus 100 according to a first exemplary embodiment. Micro check valve apparatus 100 includes substrate 101, micro introducing channel 103, micro discharging channel 102, chamber 10, and spherical valve 200.

Micro check valve apparatus 100 refers to a check valve apparatus that is used as being connected to a microchannel device.

Substrate 101

Micro introducing channel 103, micro discharging channel 102, chamber 10, and spherical valve 200 are positioned inside substrate 101.

Substrate 101 may include a plurality of substrates. For example, substrate 101 includes first substrate 101a, second substrate 101b, and third substrate 101c. FIG. 1A is a bottom view of first substrate 101a in micro check valve apparatus 100. First substrate 101a shown in FIG. 1A has second channel 102b which will be described later, and part of chamber 10.

FIG. 1B is a cross-sectional view of micro check valve apparatus 100 taken along line A-A in FIG. 1A. As shown in FIG. 1B, first substrate 101a, second substrate 101b, and third substrate 101c are positioned in order from top to bottom. Second substrate 101b has fifth channel 102a, fourth channel 102b, part of chamber 10, spherical valve 200, second channel 103a, and first channel 103b. FIG. 10 shows a top view of second substrate 101b in micro check valve apparatus 100.

Micro Introducing Channel 103 and Micro Discharging Channel 102

As shown in FIG. 1B, micro discharging channel 102 is connected to the side surface of chamber 10. Micro introducing channel 103 is connected to the bottom surface of chamber 10. In FIG. 1B, liquid upwardly introduced from micro introducing channel 103 into chamber 10 is discharged from check valve apparatus 100 passing through micro introducing channel 103, chamber 10, and micro discharging channel 102.

As shown in FIGS. 1A to 10, the exemplary micro discharging channel 102 includes fifth channel 102a extending in the direction being parallel to substrate 101, fourth channel 102b connected to fifth channel 102a and extending in the direction being perpendicular to substrate 101, and third channel 102c connected to fourth channel 102b and extending in the direction being parallel to substrate 101. As shown in FIG. 1B, third channel 102c is connected to the side surface of the chamber 10. In micro discharging channel 102, liquid discharged from chamber 10 passes through third channel 102c, fourth channel 102b, and fifth channel 102a in order.

Micro introducing channel 103 shown in FIGS. 1A to 10 includes second channel 103a connected to the bottom surface of chamber 10 and extending in the direction being perpendicular to substrate 101, and first channel 103b connected to second channel 103a and extending in the direction being parallel to substrate 101. In the micro introducing channel 103, liquid introduced into chamber 10 passes through first channel 103b and second channel 103a in order.

For example, the width of the micro introducing channel 103 and the width of the micro discharging channel 102 are each, for example, from 10 μm to 1 mm inclusive. Further, the depth of the micro introducing channel 103 and the depth of the micro discharging channel 102 are each, for example, from 10 μm to 1 mm inclusive.

Micro introducing channel 103 and micro discharging channel 102 correspond to a recess that functions as a channel formed in substrate 101.

Chamber 10

Chamber 10 is surrounded by the inner wall surface of substrate 101. Each side of the space inside chamber 10 is greater than the width or depth of the connected micro introducing channel 103 and micro discharging channel 102.

Chamber 10 includes the side surface connected to micro discharging channel 102, and the bottom surface connected to micro introducing channel 103. Liquid that has entered chamber 10 from micro introducing channel 103 flows toward micro discharging channel 102.

A cross section of chamber 10 taken perpendicularly to the traveling direction of liquid in micro introducing channel 103 becomes gradually greater in the traveling direction of the liquid from the bottom part of chamber 10 where chamber 10 is connected to micro introducing channel 103. The part of chamber 10 where chamber 10 is connected to micro introducing channel 103 is tapered. The tapered part of chamber 10 is also referred to as tapered part 10a.

Chamber 10 has projection 11 at (the recess of) the upper part of the chamber inner wall surface, which is first substrate 101a. Projection 11 projects downward. An exemplary shape of the projection may be truncated cone-like. Projection 11 has a height falling within a range from 30 μm to 100 μm inclusive. The height of projection 11 is the longest distance between the vertex of projection 11 and the upper surface of the inner wall surface of substrate 101 (in other words, the bottom surface of annular recess 111 around projection 11). For example, in FIG. 1B, the height of projection 11 corresponds to the distance between a position higher than the vertex of projection 11, which position is the highest position in chamber 10, and the vertex of projection 11.

Projection 11 is positioned at a level higher than micro introducing channel 103. More specifically, as seen in the thickness direction of substrate 101, projection 11 is positioned so as to be overlaid on opening 103e of micro introducing channel 103 which is connected to the bottom surface of chamber 10. Further, as seen in the thickness direction of substrate 101, projection 11 is positioned so as to be overlaid on spherical valve 200 which is positioned on tapered part 10a, which will be described later, and projection 11 is smaller than spherical valve 200. An exemplary shortest distance between spherical valve 200 at the position where spherical valve 200 closes opening 103e of micro introducing channel 103 and projection 11 falls within a range from 50 to 300 μm inclusive.

Note that, chamber 10 having projection 11 can be also described as chamber 10 having an upper surface that includes, adjacent to projection 11, recess 111 having a depth of 30 μm or greater. Here, recess 111 is desirably formed to surround projection 11.

Spherical Valve 200

Spherical valve 200 is positioned inside chamber 10. By being in contact with or spaced apart from tapered part 10a, spherical valve 200 closes or opens opening 103e of micro introducing channel 103. Spherical valve 200 has a diameter greater than the width of micro introducing channel 103 (opening 103e). Further, spherical valve 200 has a diameter greater than the greatest side in a cross section of micro introducing channel 103. Thus, when spherical valve 200 is positioned inside chamber 10, spherical valve 200 is capable of closing opening 103e of micro introducing channel 103.

Exemplary shapes of spherical valve 200 include spherical, elliptical, circular cylindrical, and conical. Spherical valve 200 is just required to have a spherical shape in a cross section of micro check valve apparatus 100 taken along the thickness direction of substrate 101, which spherical shape allows spherical valve 200 to be brought into contact with or spaced apart from tapered part 10a.

Before liquid enters chamber 10, spherical valve 200 is at a position where spherical valve 200 is in contact with tapered part 10a of chamber 10, so as to close opening 103e of micro introducing channel 103. Specifically, spherical valve 200 being positioned on tapered part 10a of chamber 10 closes opening 103e of micro introducing channel 103.

Spherical valve 200 may be made of a material such as, for example, SUS, alumina, or glass.

When liquid enters inside chamber 10 from opening 103e of micro introducing channel 103 at the bottom surface of chamber 10, the flowing force of the liquid pushes up spherical valve 200 inside chamber 10 from the position where spherical valve 200 has been in contact with tapered part 10a. Spherical valve 200 having been closing micro introducing channel 103 is pushed up, and the liquid flows from chamber 10 into micro discharging channel 102.

When supply of liquid from micro introducing channel 103 to chamber 10 stops, by virtue of projection 11, part of the flowing force of liquid is applied to spherical valve 200 as force that causes spherical valve 200 to return to the position where spherical valve 200 is in contact with tapered part 10a. Thus, spherical valve 200 returns to the position where spherical valve 200 is in contact with tapered part 10a. Such a structure that allows spherical valve 200 to quickly return to the position where spherical valve 200 is in contact with tapered part 10a suppresses liquid, which is once discharged by spherical valve 200 from chamber 10 to micro discharging channel 102, from flowing back into chamber 10.

Operation of Check Valve Apparatus

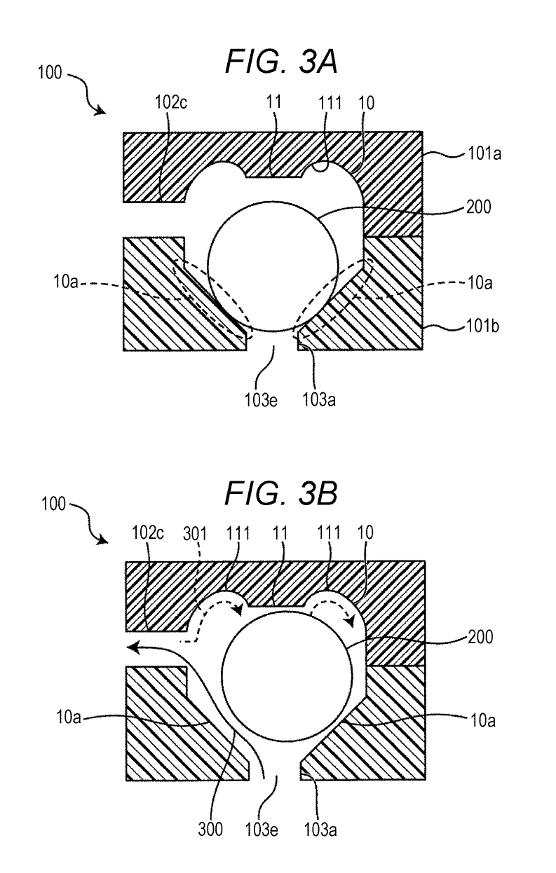

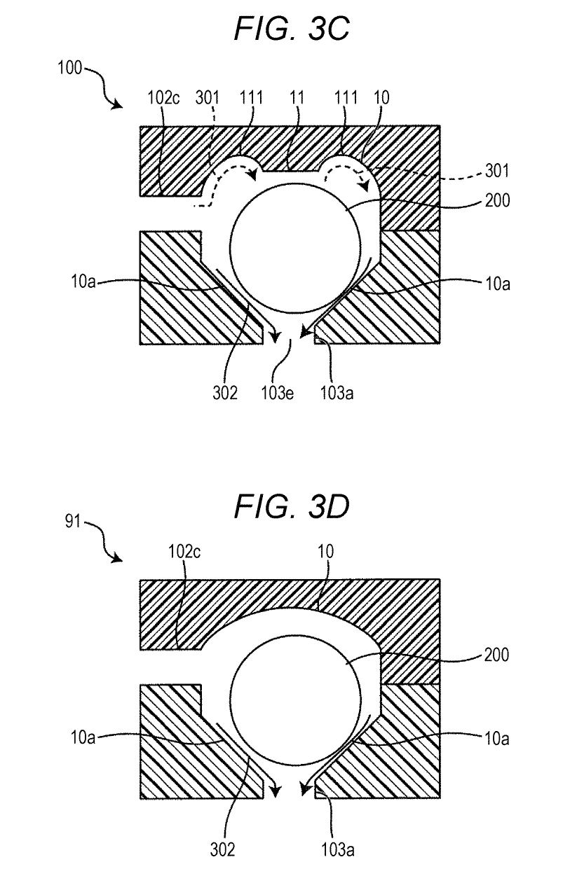

With reference to partial cross-sectional views of FIGS. 3A to 3C, a specific description will be given of the operation of micro check valve apparatus 100 according to the present exemplary embodiment. FIGS. 3A to 3C are enlarged views of chamber 10. FIGS. 3A to 3C show states of chamber 10, from the state before liquid is introduced into chamber 10 to the state after the liquid is discharged from chamber 10 in time sequence.

FIG. 3A shows the state before liquid is introduced into chamber 10. Spherical valve 200 is disposed to be in contact with tapered part 10a in chamber 10, so as to close opening 103e of micro introducing channel 103. In FIG. 3A, tapered part 10a is the part encircled by broken lines.

FIG. 3B shows the state where liquid is being introduced into chamber 10, pushing up spherical valve 200 having been closing micro introducing channel 103. The liquid introduced into second channel 103a of micro introducing channel 103 pushes up spherical valve 200 from the bottom part of chamber 10 and introduced into chamber 10. Arrow 300 in FIG. 3B represents flow of the liquid introduced into chamber 10. The force of the liquid flow 300 introduced into chamber 10 is applied to spherical valve 200, and spherical valve 200 is pushed up from tapered part 10a and shifts to an upper part in chamber 10.

The liquid having changed the position of spherical valve 200 having been closing micro introducing channel 10 and thereby entered chamber 10 then enters micro discharging channel 102 positioned beside chamber 10. Spherical valve 200 having shifted to the upper part in chamber 10 receives the maximum force from liquid flow 300. The spherical valve 200 shifting to the upper part narrows the space between the wall surface of chamber 10 and spherical valve 200. In the force of liquid flow 301 that branches from liquid flow 300 and passes through the space between the wall surface of chamber 10 and spherical valve 200, which space includes recess 111, viscous force is dominant than inertial force.

FIG. 3C shows the state where the introduction of liquid from micro introducing channel 103 to chamber 10 is stopped. The liquid introduced from second channel 103a to chamber 10 becomes extinct, and there exists only liquid flow 302 that flows back from micro discharging channel 102 and chamber 10 to second channel 103a of micro introducing channel 103. Also, the force applied to spherical valve 200 by entering liquid flow 300 becomes extinct, and there exist only force applied to spherical valve 200 by liquid flow 302 which flows back, and force applied to spherical valve 200 by liquid flow 301 between the wall surface of chamber 10 including recess 111 and spherical valve 200. Thus, spherical valve 200 shifts downward.

After flow of liquid becomes extinct inside chamber 10, as shown in FIG. 3A, spherical valve 200 shifts downward to return to the position where spherical valve 200 is in contact with tapered part 10a. As a result, spherical valve 200 closes opening 103e of micro introducing channel 103, preventing liquid from flowing back from micro discharging channel 102 and chamber 10 to micro introducing channel 103. That is, spherical valve 200 prevents backflow of liquid from chamber 10 to micro introducing channel 103.

More specifically, a description will be given of the operation of spherical valve 200 returning to the position where spherical valve 200 is in contact with tapered part 10a. As shown in FIG. 3C, introduction of liquid from second channel 103a of micro introducing channel 103 into chamber 10 is stopped, and liquid inside micro discharging channel 102 and chamber 10 flows back to second channel 103a through the clearance between spherical valve 200 and tapered part 10a.

Here, spherical valve 200 receives force in the direction of liquid that flows back through the clearance between spherical valve 200 and tapered part 10a. The force shifts spherical valve 200 downward so as to approach second channel 103a. That is, spherical valve 200 approaches tapered part 10a.

The magnitude of force attributed to flow of liquid varies depending on the Reynolds number of the liquid. In the Reynolds number, the inertial force and the viscous force are variables. For example, the Reynolds number of liquid in a check valve apparatus having a length or width of several millimeters or greater is great, because the inertial force is dominant. That is, the force of liquid is great. Accordingly, with a check valve apparatus having a length or width of several millimeters or greater, flow of liquid exerts great force in the direction of closing the valve.

On the other hand, as in the present exemplary embodiment, when micro introducing channel 103, chamber 10, and micro discharging channel 102 each have a dimension of a predetermined value or smaller (for example, a width and a depth each falling within a range from 10 μm to 1 mm inclusive), the viscous force of liquid becomes dominant and therefore the Reynolds number is small. That is, the force that causes spherical valve 200 to approach tapered part 10a is small. Hence, the time required for spherical valve 200 to approach tapered part 10a becomes longer. The long time increases the amount of liquid flowing back from chamber 10 to micro introducing channel 103.

Addressing thereto, with micro check valve apparatus 100 according to the present exemplary embodiment, projection 11 generates liquid flow 301 at recess 111. Liquid flow 301 creates the force that causes spherical valve 200 to approach tapered part 10a. As shown in FIG. 3B, in the case where there exists liquid flow 300 that enters chamber 10 from second channel 103a of micro introducing channel 103, liquid flow 300 is greater in force than liquid flow 301. Accordingly, spherical valve 200 does not return to tapered part 10a and is positioned at an upper part in chamber 10.

However, as shown in FIG. 3C, when liquid flow 300 becomes extinct and there is generated liquid flow 302 that flows back from inside micro discharging channel 102 and chamber 10 through the clearance between spherical valve 200 and tapered part 10a to micro introducing channel 103, in addition to liquid flow 302, liquid flow 301 generated by projection 11 also becomes the force that causes spherical valve 200 to return to tapered part 10a. Thus, spherical valve 200 is returned to tapered part 10a quicker, reducing backflow of liquid from micro discharging channel 102 and chamber 10 to micro introducing channel 103.

In this manner, projection 11 generates, separately from liquid flow 302, liquid flow 301 on the right and left sides of projection 11 in cross-sectional views of chamber 10 of FIGS. 3B and 3C. Thus, the force that causes spherical valve 200 to approach tapered part 10a is evenly applied onto the top of spherical valve 200.

Operation of Micro Check Valve Apparatus without Projection

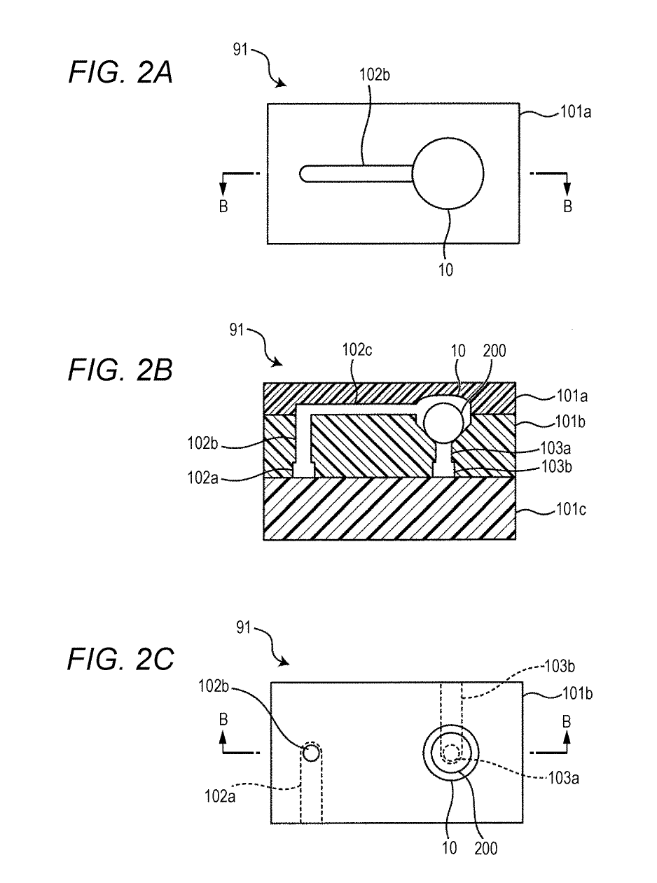

For comparison, with reference to FIG. 3D, a description will be given of micro check valve apparatus 91 without the projection shown in FIGS. 2A to 2C. Micro check valve apparatus 91 without the projection shown in FIGS. 2A to 2C is structured identically to micro check valve apparatus 100 according to the present exemplary embodiment shown in FIGS. 1A to 10, except that micro check valve apparatus 91 does not include projection 11. FIG. 2A is a top view of first substrate 101a of micro check valve apparatus 91 without the projection. FIG. 2B is a vertical cross-sectional view taken along line B-B in FIG. 2A. FIG. 2C is a top view of second substrate 101b in micro check valve apparatus 91 without the projection.

Specifically, as shown in FIG. 2B, micro check valve apparatus 91 without the projection does not have projection 11 at the inner wall surface of chamber 10, and the upper inner wall surface of chamber 10 is smoothly recessed.

FIG. 3D shows a state similar to that shown in FIG. 3C. Liquid flow 301 that is generated by projection 11 of micro check valve apparatus 100 shown in FIG. 3C is not generated with micro check valve apparatus 91 without the projection shown in FIG. 3D. Accordingly, micro check valve apparatus 91 without the projection lacks the force for causing spherical valve 200 to return to tapered part 10a, which is otherwise provided by liquid flow 301. As compared to micro check valve apparatus 100, micro check valve apparatus 91 without the projection requires longer time for spherical valve 200 to return to tapered part 10a, and increases the amount of liquid flowing back from micro discharging channel 102 and chamber 10 to micro introducing channel 103.

### EXPERIMENTAL EXAMPLES

Experimental examples demonstrate the exemplary embodiment of the present disclosure in more detail. The inventors of the present disclosure have conducted the following experiments for proving the relationship between projection 11 and the performance of micro check valve apparatus 100.

### First Experimental Example

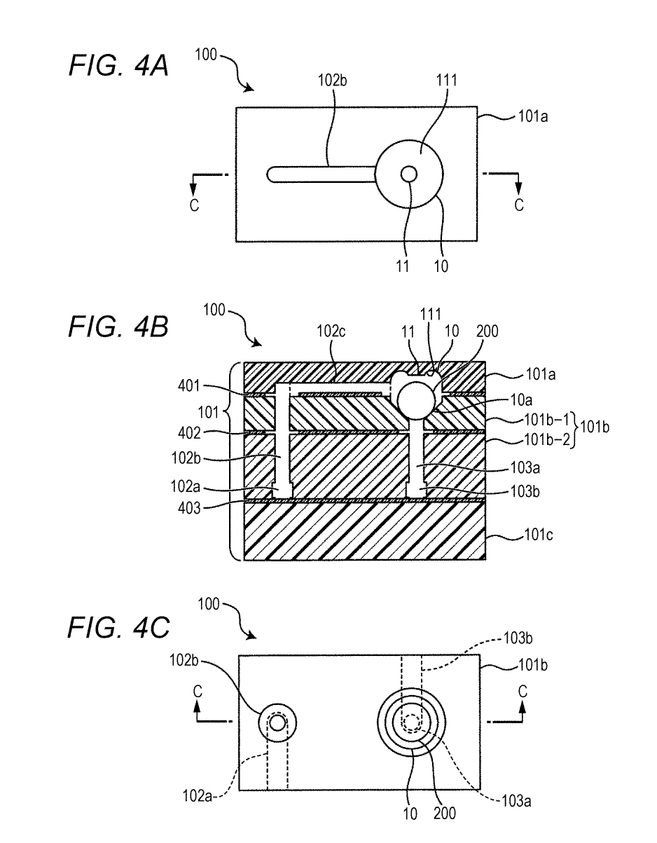

Micro check valve apparatus 100 according to a first experimental example shown in FIGS. 4A to 4C was manufactured. FIGS. 4A to 4C respectively correspond to FIGS. 1A to 10. Second substrate 101b in micro check valve apparatus 100 shown in FIGS. 4A to 4C was structured by two substrates 101 b-1, 101b-2. FIG. 4A is a top view of first substrate 101a of micro check valve apparatus 100 according to the first experimental example. FIG. 4B is a vertical cross-sectional view taken along line C-C in FIG. 4A. FIG. 4C is a top view of micro check valve apparatus 100 excluding first substrate 101a.

Further, micro check valve apparatus 100 according to the first experimental example was structured identically to micro check valve apparatus 100 shown in FIGS. 1A to 10 except that it includes first bonding layer 401 between first substrate 101a and second substrate 101b, second bonding layer 402 between the plurality of second substrates 101b-1, 101b-2, and third bonding layer 403 between second substrate 101b and third substrate 101c. Note that, provision of first bonding layer 401, second bonding layer 402, and third bonding layer 403 does not influence the performance of micro check valve apparatus 100.

The material of substrate 101 was polydimethylpolysiloxane. The shape of tapered part 10a of chamber 10 is flat. The material of spherical valve 200 was glass. The specific gravity of glass was 2.5.

Measurement of Performance of Micro Check Valve Apparatus 100

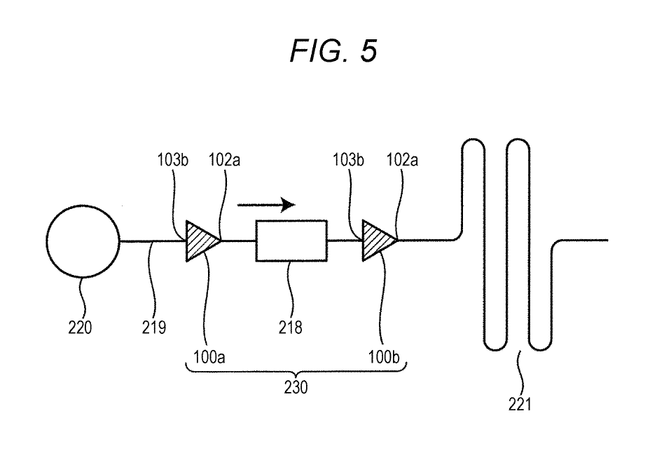

The performance of micro check valve apparatus 100 was measured with a measurement system shown in FIG. 5. FIG. 5 conceptually shows the measurement system. The measurement system shown in FIG. 5 includes liquid reservoir 220 for introducing test liquid, measurement chamber 218 having a diaphragm pump, a plurality of micro check valve apparatuses 100 (100a, 100b), measurement channel 221, and coupling channel 219.

Liquid reservoir 220, micro check valve apparatus 100a, measurement chamber 218, micro check valve apparatus 100b, and measurement channel 221 were connected in this order by coupling channel 219. Liquid was transferred in the direction represented by arrow in FIG. 5 (in order of liquid reservoir 220, micro check valve apparatus 100a, measurement chamber 218, micro check valve apparatus 100b, and measurement channel 221). Allowing micro check valve apparatus 100a, measurement chamber 218, and micro check valve apparatus 100b to function as diaphragm-type pump 230, the performance of micro check valve apparatus 100 was measured.

The inlet of measurement chamber 218 was connected to micro check valve apparatus 100a, and the outlet of measurement chamber 218 was connected to micro check valve apparatus 100b.

As the diaphragm of measurement chamber 218 was pulled, negative pressure was created inside. Thus, liquid in coupling channel 219 was sucked from fifth channel 102a of micro check valve apparatus 100a to measurement chamber 218. As a result, on the upstream side of micro check valve apparatus 100a, liquid was introduced from coupling channel 219 into micro check valve apparatus 100a via first channel 103b of micro check valve apparatus 100a; and on the downstream side of micro check valve apparatus 100a, the introduced liquid was sent to coupling channel 219 from fifth channel 102a of micro check valve apparatus 100a. As the diaphragm of measurement chamber 218 was pushed, the liquid was introduced from coupling channel 219 into micro check valve apparatus 100b via first channel 103b of micro check valve apparatus 100b; and on the downstream side of micro check valve apparatus 100b, the introduced liquid was discharged from fifth channel 102a of micro check valve apparatus 100b to coupling channel 219. The liquid discharged from fifth channel 102a of micro check valve apparatus 100b arrived at measurement channel 221 via coupling channel 219. The flow rate of the liquid arrived at measurement channel 221 was measured.

### Comparative Example

Check valve apparatus 91 according to a comparative example was fabricated identically to micro check valve apparatus 100 according to the exemplary embodiment excluding projection 11. Check valve apparatus 91 according to the comparative example was similar to check valve apparatus 91 shown in FIGS. 2A to 2C. The measurement method performed with check valve apparatus 91 according to the comparative example with the measurement system shown in FIG. 5 was similar to that performed with check valve apparatus 100 according to the exemplary embodiment, except that chamber 10 did not have the projection.

Method for Manufacturing Pump

As to the chamber and the liquid reservoir being the constituent elements of the pump, they were integrally designed on a common substrate, and simultaneously fabricated by the technique identical to that of the valve.

Pump

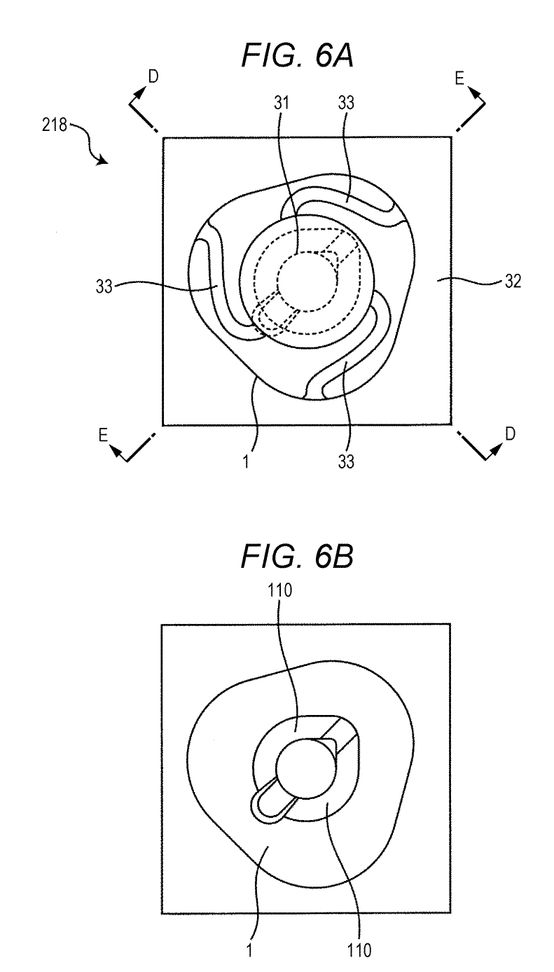

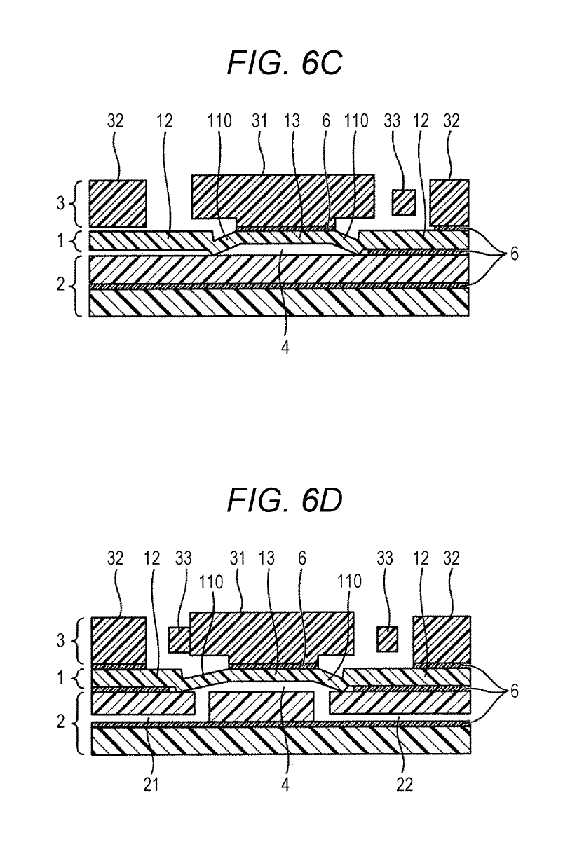

FIGS. 6A to 6C show a specific structure of the pump. Measurement chamber 218 (see FIG. 5) includes substrate layer 2, diaphragm layer 1, top layer 3, and pump chamber 4 surrounded by diaphragm layer 1 and substrate layer 2. Substrate layer 2, diaphragm layer 1, and top layer 3 were positioned in this order from bottom to top. Between substrate layer 2 and diaphragm layer 1 and between diaphragm layer 1 and top layer 3 were fixed with bonding layer 6.

FIG. 6A is a top view of measurement chamber 218. Top layer 3 has top 31, spring 33, and frame 32. Top 31 and frame 32 are connected to each other with spring 33.

Top layer 3 was fabricated by subjecting a substrate to cutting or injection molding. Top 31 was supported by spring 33 at three points.

FIG. 6B is a top view of measurement chamber 218 excluding top layer 3. Diaphragm layer 1 was fabricated by subjecting a substrate to injection molding.

FIG. 6C is a cross-sectional view taken along line D-D in FIG. 6A. Diaphragm layer 1 has fixing part 12, pump layer 13, and deforming part 110. FIG. 6D is a cross-sectional view taken along line E-E in FIG. 6A. Substrate layer 2 has introducing channel 21 and discharging channel 22. Liquid is introduced into pump chamber 4 via introducing channel 21. The liquid is discharged from pump chamber 4 via discharging channel 22.

Downward force applied to top 31 deforms deforming part 110, and pump layer 13 shifts toward substrate layer 2, eliminating the space of pump chamber 4. Further, spring 33 applying upward force to top 31 deforms deforming part 110, and pump layer 13 shifts upward, increasing the space of pump chamber 4 (the state shown in FIG. 6C is recovered). In this manner, measurement chamber 218 functioned as a pump.

Valve

Next, a description will be given of works on the valve. The layers structuring the valve were all identical to the layers structuring the pump, and formed simultaneously with the works on the pump. Further, the valve element was a stainless steel ball having a diameter of 0.5 mm.

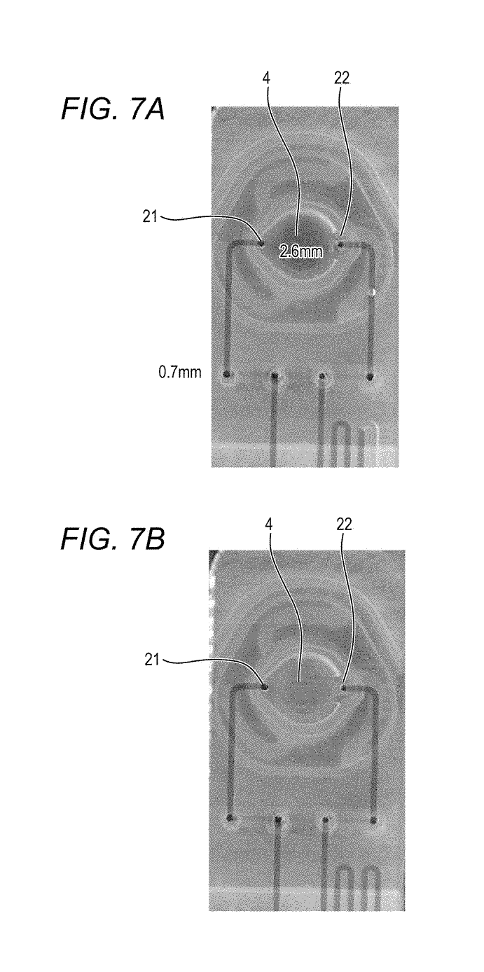

FIGS. 7A and 7B are photographs of the pump formed in a chip taken from its lower surface side. Liquid introduced into the channels appears in deep color. This liquid was a model of test liquid subjected to biological analysis, and was an aqueous solution of amphiphilic polymer Pluronic F127 available from Sigma-Aldrich, to which pigment was added.

FIG. 7A shows the state where liquid is introduced into pump chamber (chamber) 4. Further, FIG. 7B shows the state where top 31 is pushed to eliminate the space of pump chamber (chamber) 4, whereby liquid in pump chamber (chamber) 4 is entirely expelled.

A series of operations of introducing liquid into chamber 4 and discharging the liquid is referred to as a stroke operation. When the check valve apparatus completely operates without any backflow, ideally liquid is fed by 0.32 μL per stroke. The speed of stroke depends on the speed of pushing or pulling the handle, and was about 0.5 seconds in the present experiment. The performance of the check valve apparatus was evaluated by estimating the feed amount per stroke from images of movement of liquid in the channels taken with a camera. The pumps used in the experiment were three types, namely, the pump structured with the check valve apparatus according to the exemplary embodiment of the present disclosure, a pump structured with a conventional shallow check valve apparatus, and a conventional deep check valve apparatus. For each of the three types, identical four pumps were fabricated. For each of the pumps, the feed amount for five strokes was measured. Then, the feed amount per stroke was obtained.

The result of the experiment showed that the feed amount per stroke of the pump structured by the check valve apparatus according to the exemplary embodiment was 0.29 μL±0.01 μL, with the error from the design value falling within a range of 10%. The feed amount per stroke of the pump structured with the conventional shallow check valve apparatus was 0.07 μL±0.05 μL, and the feed amount per stroke of the pump structured with the conventional deep check valve apparatus was 0.14 μL±0.04 μL.

As the experimental result proves, the check valve apparatus according to the exemplary embodiment provides an accurate feed amount and operates with a smaller backflow amount, as compared to the conventional check valve apparatus whose feed amount per stroke is unstable and associated with a greater backflow amount.

Further, as to the check valve apparatuses according to the comparative example, the pump structured by the check valve apparatus having a shallow groove was lower in performance than the pump structured by the check valve apparatus having a deep groove according to the comparative example. This is explained as follows. With the shallow groove, the space becomes small when the spherical valve floats, and therefore the effect of viscous flow acts great. As a result, the shift amount of the spherical valve becomes small despite liquid flowing, and the spherical valve tends to return to the initial position.

Note that, the check valve apparatus according to the exemplary embodiment was associated with a further reduced backflow amount as compared to both of the check valve apparatuses according to the comparative example.

As has been described above, the exemplary embodiment of the present disclosure is useful as a check valve apparatus which provides accurate flow rectifying effect. Furthermore, as a component of a pump, the exemplary embodiment of the present disclosure contributes toward providing a pump achieving an accurate feed amount.

### Other Experimental Example

In the following, a description will be given of the result of the study of the optimum shape previously conducted according to the parameter design scheme, in devising the micro check valve apparatus.

Table 1 shows control factors and levels.

TABLE 1

| Factor | Level 1 | Level 2 | Level 3 |
|---|---|---|---|
| Type of valve element | Glass | SUS | Alumina |
| (specific gravity) | (2.5) | (7.8) | (3.9) |
| Shape of tapering | Flat | 0.5R | 1R |
| Ceiling | Projection | Depth 0.1 | Depth 0.2 |

As the control factors, three factors were employed, namely, the type of the valve element (specific gravity), the shape of the tapered part, and the depression shape of the space (the depression or the recess around the projection). Further, as the type of the valve element (specific gravity) corresponding to levels 1, 2, and 3, glass (2.5), stainless steel, e.g., SUS (7.8), and alumina (3.9) were respectively employed. Each sphere as the valve element had a diameter of 0.5 mm.

Further, as the shape of the tapered part corresponding to levels 1, 2, and 3, which is the tapered part in the cross section taken along line A-A in FIG. 4B, a straight line (flat), a curved line having a radius of 0.5 mm, and a curved line having a radius of 1 mm were employed.

Still further, as the shape of the depression (ceiling) formed at chamber 10 of substrate 101 corresponding to levels 1, 2, and 3, the three modes prototyped in the above-described experimental example, namely, the shape of the exemplary embodiment of the present disclosure (projection), the shape of the conventional shallow example (depth 0.1 mm), and the conventional deep example (depth 0.2 mm) were employed.

Table 2 shows noise factors.

TABLE 2

| Factor | Level 1 (N1) | Level 2 (N2) |
|---|---|---|
| Pluronic | 0.3 wt %/V | None |
| Stroke (sec) | 0.5 | 3 |

Level 1 (N1) was set as the condition for a superior operation, and level 2 (N2) was set as the condition for an inferior operation. Presence/absence of Pluronic F127 being amphiphilic polymer available from Sigma-Aldrich, and the speed of stroke were employed. The amphiphilic polymer normally improves wettability, prevents any element, such as bubbles, from being attached to the wall surface, and ensures the effect of the fluid.

However, in the present experiment, the residual bubbles did not seem to be influential in every test. Therefore, this factor may not be significantly influential. Further, the smaller the stroke speed is, the greater the viscous drag specific to μ channels becomes.

With the two factors in the left column, in level 1 (N1), the stroke speed of about 0.5 seconds and an aqueous solution containing Pluronic are set as the condition for a superior operation.

Note that, level 1 (N1) is the standard operational condition of the present company, and the flow velocity is about 38 μL/min. Further, level 2 (N2) is a condition disadvantageous for the operation of the check valve apparatus. In level 2 (N2), no Pluronic was contained, and the flow velocity was reduced to about 5 μL/min.

In the present experiment, the factors were allocated to orthogonal array L₉ (3⁴). The fourth column in the factor columns shows dummy factors. Table 3 shows the orthogonal array.

TABLE 3
L₉ (3⁴) Orthogonal array

Factor columns

| Element No. | A | B | C | D |
|---|---|---|---|---|
| 1 | 1 | 1 | 1 | 1 |
| 2 | 1 | 2 | 2 | 2 |
| 3 | 1 | 3 | 3 | 3 |
| 4 | 2 | 1 | 2 | 3 |
| 5 | 2 | 2 | 3 | 1 |
| 6 | 2 | 3 | 1 | 2 |
| 7 | 3 | 1 | 3 | 2 |
| 8 | 3 | 2 | 1 | 3 |
| 9 | 3 | 3 | 2 | 1 |

Nine types of elements L₉ (3⁴) were fabricated by six pieces each, e.g., 54 elements in total, so that three pieces were evaluated for noise factor N1 and three pieces were evaluated for noise factor N2. However, in the prototyping, due to failure in the injection molding of PDMS (polydimethylpolysiloxane) structuring substrate 101, a hole that continued to through hole was not bored, leaving a thin film between the hole and through hole in some elements. Accordingly, a number of elements which were actually subjected to the pump liquid feed test were 26. Whether or not the thin film was present were visually recognized and screened with a microscope by disassembling the chip after the experiment.

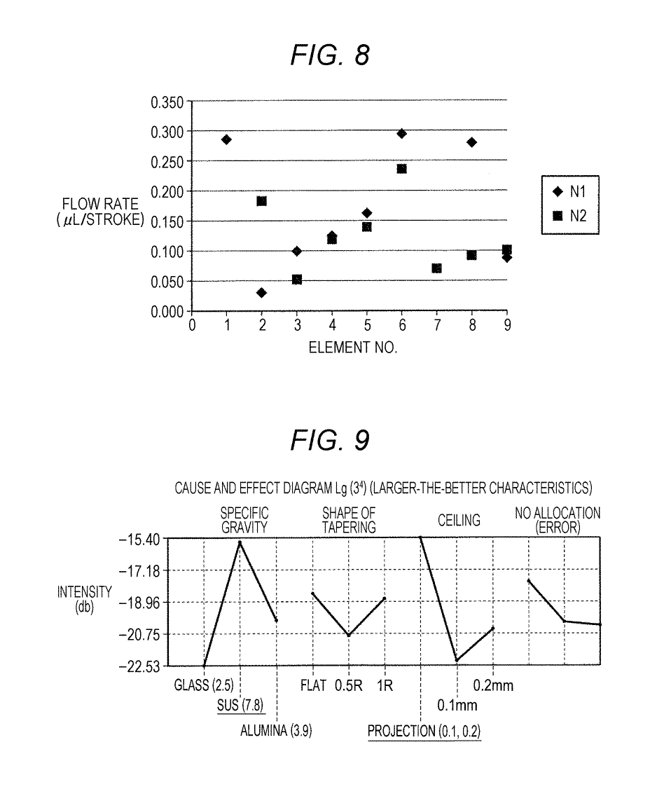

FIG. 8 shows the experimental result of 26 elements in total. Element NO.1 in N2 were all defective and could not be tested, and accordingly were subjected to estimation processing as a missing value. That is, the average value of S/N ratio of the experimental values excluding the missing value was employed as the S/N ratio of the missing value. Further, the missing value was estimated from analysis of variance and determined as the tentative missing value. Next, the S/N ratio including the tentative missing value was obtained. Further, by successive approximation, in which estimation of the missing value from analysis of variance is repeated, the estimated value was converged.

FIG. 9 is a factor and effect graph of the larger-the-better characteristics obtained by the analysis of variance of the experimental result. The factor with a larger change in intensity is the factor that influences the effect greater. Further, the factors not allocated are dummy factors, and represent the magnitude of experimental error. That is, the experimental result contains error as great as the distribution of the dummy factors. In view of the error, it is still evident that the shape of the tapered part little influences the performance of the check valve apparatus. Further, as to the valve element, the result shows that simply the greater the specific gravity of the valve element is, the shorter the time required for the valve element to fall onto the tapered part becomes, i.e., the quicker the valve closes. On the other hand, as to the shape of the depression at the ceiling, the result indicates that the difference in depth of the depression little influences the performance, and provision of the projection largely improves the performance.

As has been described above, the check valve apparatus according to the present exemplary embodiment provides a check valve apparatus which can be manufactured with ease with the method and materials equivalent to those of the conventional check valve apparatus, while being associated with a reduced amount of backflow amount than the conventional check valve apparatus and thus exhibiting accurate flow rectifying effect. That is, upon occurrence of backflow when the spherical valve is closing, the upper surface having the projection increases the flow that pushes the spherical valve. Thus, the present exemplary embodiment provides the micro check valve apparatus with a reduced backflow amount and reduced variations among the chips.

Underlying Knowledge Forming Basis of the Present Disclosure

A micro check valve apparatus desirably has a structure with fine dimensions and fewer clearances, in order to reduce the dead volume of liquid remaining in the check valve apparatus. Further, in order to be useable with a small external apparatus, the micro check valve apparatus desirably does not require a motive power source external to the chip, and automatically operates in accordance with the direction of flow. In order to achieve such a structure, there is a well-known check valve apparatus having the structure including a circular cylindrical channel. A tapered part is provided midway in the channel. A spherical element fits to the tapered part. That is, the spherical element serving as a valve element fitting to the tapered part closes the valve and stops flow. The spherical element floating from the tapered part opens the valve and passes the flow. Since the opening and closing of the valve is determined by the direction of flow, this operation of the spherical element realizes the function of stopping any backflow. Conventionally, PTL 1 discloses a structure of a micro check valve that is suitably mounted in a card-like chip. Further, NPL 1 discloses a prototype of a micro check valve.

Conventionally, micro check valves of various kinds have been proposed and prototyped. NPL 2 summarizes such approaches. There are reported four cases, including NPL 1, of a check valve of one scheme in which a spherical element floats from a tapered part. However, in every case, the operational flow velocity is of the order of mL/min and backflow occurs in an amount of the order of mL. Accordingly, they are not applicable to μ-TAS chip. Further, there is also proposed a check valve of other scheme in which part of a fin-like valve element is fixed to a valve seat. Here, leakage of liquid not easily occurs since elastic force exerted by the part fixed to the valve seat bears the force of closing the channel. On the other hand, there exist only costly techniques for manufacturing this check valve such as Si-MEMS, because of the required pressure difference for bending the elastic member for opening the valve, and required high alignment precision for fully eliminating the dead volume.

As to the check valve which operates by the spherical element floating from the tapered part, flow is viscous in a microchannel. The movement of the valve element most basically follows the behavior of an object place in fluid according to the Hagen-Poiseuille equation of the Navier-Stokes equations. The valve element approaches or becomes spaced apart from the tapered part by flow generated around the valve element. In a period until the valve element reaches the tapered part and blocks the flow, backflow occurs. The smaller the backflow amount is, the greater the flow rectifying effect becomes. Accordingly, this check valve functions excellently as a check valve.

In view of industrial manufacturability, the range of practical diameter is specified to some extent. The spherical element serving as a valve element is desirably as small as possible. On the other hand, an available or manufacturable dimension is about a diameter of φ 0.5 mm to 1 mm. The check valve apparatus is designed so as to be large enough to house the valve element, and to minimize the dead volume. Further, the thickness of the chip is desirably about one millimeter to several millimeters. Accordingly, in order to reduce the installation volume of the check valve apparatus to fall within the dimension of the chip, as in NPL 1, the channel connected to the check valve apparatus is connected in the direction parallel to the substrate structuring the chip, that is, connected laterally. On the other hand, with the micro check valve in PTL 1, the channel is perpendicularly connected to the tapered part. This increases a number of the substrate and the bonding layer structuring the channel each by one.

Further, because of its high costs and not being manufacturable, no actual prototype has been reported.

The micro check valve which employs a spherical element as a valve element is well known as one mode of check valves. However, when a micro check valve is prototyped based simply on the conventional design with reduced dimensions, the backflow cannot actually be prevented. Hence, the conventional micro check valves of this type have been failed to fully exhibit its performance.

For example, while NPL 1 has successfully fabricated the basic structure, the micro check valve requires the flow velocity of the order of mL/min for operation, and also backflow is of the order of mL. This means that, even a fluid like water becomes viscous when it flows through a microchannel; the valve element does not shift at full speed unless the influence of the viscous flow is weakened by an increased flow velocity; the function as a check valve becomes significantly poor; and therefore the micro check valve in NPL 1 is not applicable to the liquid feeding operation of the order of μL. Hence, despite the conventional micro check valve being space-saving, being manufacturable for its simple structure, and being manufacturable in dimensions applicable to use with a disposal small μ-TAS chip, the conventional check valve is not applicable to a μ-TAS apparatus.

Further, setting the flow of fluid around the valve element to be linear, such as providing a tapered channel being greater in length than the size of the valve element as in PTL 1, flow that causes the valve element to approach the tapered part can be surely generated. However, the volume of the channel around the valve element disadvantageously becomes great relative to the valve element. This increases the amount of liquid remaining in the check valve, that is, the dead volume, impairing the characteristic of μ-TAS, which is the capability of carrying out analysis with a small amount of liquid. Further, as has been described above, this increases the shifting distance of the valve element and increases the backflow amount. Further, the check valve in which the channel is linearly disposed increases the thickness of the chip, which hinders miniaturization. Conversely, in the case where the valve element is reduced in size so as to be located in the linear flow, it is difficult to manufacture the small valve element and dispose the same in the substrate, whereby manufacturing costs increases.

### Other Exemplary Modes of the Present Disclosure

A first aspect of the present disclosure provides a micro check valve apparatus (e.g., micro check valve apparatus 100) that includes a microchannel, which is a space formed by a cover (e.g., first substrate 101a) being fixed to a substrate (e.g., second substrate 101b) having a groove on its surface. In the channel, a chamber (e.g., chamber 10) is formed. Channels (e.g., micro discharging channel 102 and micro introducing channel 103) are respectively connected to the side surface of the chamber and the bottom surface of the chamber. The channel on the bottom surface side of the chamber (e.g., micro introducing channel 103) is connected to an external channel via a through hole formed at the chamber bottom surface. The through hole has a tapered part (e.g., tapered part 10a) which becomes downwardly narrower. A spherical valve element (e.g., spherical valve 200) is positioned on the tapered part. A projecting structure (e.g., projection 11) is formed at the surface of the cover on the chamber side. The projecting structure is for example disposed around the center line of the through hole.

In the present structure, flow of fluid from the through hole (e.g., micro introducing channel 103) that pushes the valve element causes the valve element to float in the chamber to open the valve. Thereafter, when the flow of the fluid pushing the valve element stops, the flow of the fluid in the chamber is reversed, whereby the valve closes. Here, viscous fluid around the projecting structure pushes the valve element toward the through hole and causes the effect of causing the valve element to approach the tapered part. Thus, the effect of the valve element quickly approaching the tapered part is obtained. This solves the problem of disadvantageous occurrence of a large amount of backflow before the valve closes. Thus, manufacture of a micro check valve apparatus with a reduced backflow amount is facilitated.

A second aspect provides the micro check valve apparatus according to the first aspect in which the projection is formed on the surface of a depression formed at the cover.

In the present structure, flow of fluid from the through hole that pushes the valve element causes the valve element to float in the chamber to open the valve. Thereafter, when the flow of the fluid in the chamber is reversed and the valve is closed, viscous fluid around the projecting structure pushes the valve element toward the through hole and causes the effect of causing the valve element to approach the tapered part. Thus, the effect of the valve element quickly approaching the tapered part is obtained. This solves the problem of disadvantageous occurrence of a large amount of backflow before the valve closes. The manufacture of the micro check valve apparatus with a reduced backflow amount is facilitated also with a chip designed to have a reduced thickness by housing the valve element in the tapered part of the substrate and the depression of the cover.

A third aspect provides the micro check valve apparatus according to one of the first and second aspects, in which the projection projects from the surface of the cover on the chamber side by 30 μm or greater. When the valve element is positioned on the tapered part, the distance between the surface of the projection and the valve element falls within a range from 50 μm to 300 μm inclusive. The width of a flat part at a top part of the projection that opposes to the valve element is equal to or smaller than the diameter of the valve element.

In the present structure, flow of fluid from the through hole that pushes the valve element causes the valve element to float in the chamber to open the valve. Thereafter, when the flow of the fluid pushing the valve element stops, the flow of the fluid in the chamber is reversed, whereby the valve closes. Here, by the projection projecting from the surface of the cover on the chamber side by 30 μm or greater, viscous fluid around the projecting structure pushes the valve element toward the through hole, exhibiting the effect of causing the valve element to approach the tapered part. Further, setting the distance between the surface of the projection and the valve element to fall within a range from 50 μm to 300 μm inclusive, the flow rate of backflow toward the tapered part becomes small and viscous drag becomes relatively great. This relatively increases the effect of pushing the valve element toward the through hole. Thus, the effect of the valve element quickly approaching the tapered part is obtained. Further, the valve element does not largely shift upward. Still further, by the width of the flat part at the top part of the projection being equal to or smaller than the diameter of the valve element, the effect of pushing the valve element toward the through hole becomes great. Hence, in closing the valve, the valve element floating inside the chamber quickly returns to the tapered part. This solves the problem of disadvantageous occurrence of a large amount of backflow before the valve closes. Thus, manufacture of a micro check valve apparatus with a reduced backflow amount is facilitated.

### The Effect of the Present Disclosure

With micro check valve apparatus 100 according to one aspects of the present disclosure, when liquid supply from micro introducing channel 103 to chamber 10 stops, projection 11 causes part of force of liquid flowing in chamber 10 to be applied to spherical valve 200 as force that returns spherical valve 200 to the position where spherical valve 200 is in contact with tapered part 10a. Thus, spherical valve 200 can quickly return to the position where spherical valve 200 is in contact with tapered part 10a. This suppresses liquid discharged by spherical valve 200 from chamber 10 into micro discharging channel 102 from flowing back into chamber 10.

Note that, any appropriate combination of the various exemplary embodiments and Variations can achieve their respective effects. Further, a combination of exemplary embodiments, a combination of examples, or a combination of an exemplary embodiment and an example is also effective. Still further, a combination of characteristics in different exemplary embodiments or examples is also effective.

The micro check valve apparatus of the present disclosure is a check valve apparatus with a reduced backflow amount, for example as a check valve apparatus structured in a card-like chip and automatically operates according to the flow direction, with a reduced dead volume. Further, the micro check valve apparatus of the present disclosure as being disposed in flow occurring in a diaphragm-type chamber can be used as a component of a μ-TAS apparatus, forming a continuous liquid feed pump that rectifies flow, with a reduced backflow amount and an accurate flow rate.

### REFERENCE SIGNS LIST

1: diaphragm layer
2: substrate layer
3: top layer
4: pump chamber
10: chamber
10a: tapered part
11: projection
12: fixing part
13: pump layer
21: introducing channel
22: discharging channel
31: top
32: frame
33: spring
91: micro check valve apparatus without projection
100, 100a, 100b: micro check valve apparatus
101: substrate
101a: first substrate
101b, 101b-1, 101b-2: second substrate
101c: third substrate
102: micro discharging channel
102a: fifth channel
102b: fourth channel
102c: third channel
103: micro introducing channel
103a: second channel 103b first channel
103e: opening of micro introducing channel
110: deforming part
111: recess around projection
200: spherical valve
218: measurement chamber
219: coupling channel
220: liquid reservoir
221: measurement channel
300: flow of liquid in entered chamber
301: flow of liquid passing between wall surface of chamber and spherical valve
302: flow of liquid that flows back
401, 402, 403: bonding layer

What is claimed is:

1. A micro check valve apparatus, comprising:
a substrate;
a chamber that is positioned inside the substrate and has an upper surface having a projection, and a tapered part positioned at a lower part of the chamber;
a micro discharging channel connected to a side surface of the chamber;
a micro introducing channel connected to a bottom of the tapered part of the chamber via an opening; and
a spherical valve that is capable of opening and closing the opening of the micro introducing channel by shifting upward and downward in the chamber to be spaced apart from and brought into contact with the tapered part,
wherein
a recess is formed around the projection; and
when flow of fluid from the micro introducing channel to the chamber stops, flow of fluid in the recess around the projection pushes the spherical valve to be brought into contact with the tapered part to close the opening.

2. The micro check valve apparatus according to claim 1, wherein
the projection is positioned to be overlaid on the opening as seen in a thickness direction of the substrate.

3. The micro check valve apparatus according to claim 1, wherein
the projection has a height not less than 30 μm and not more than 100 μm.

4. The micro check valve apparatus according to claim 1, wherein
a shortest distance between the spherical valve at a position where the spherical valve closes the opening and the projection is not less than 50 μm and not more than 300 μm.

5. The micro check valve apparatus according to claim 1, wherein
a width of a flat part at a top part of the projection is equal to or smaller than a diameter of the spherical valve.
